(19) United States
(12) Patent Application Publication
(10) Pub. No.: US 2006/0104555 A1
(43) Pub. Date: May 18, 2006

(54) Fluid dynamic bearing arrangement

(76) Inventor: Dieter Braun, Spaichingen (DE)

Correspondence Address: NORMAN H. ZIVIN;Cooper & Dunham LLP, 1185 Avenue of the Americas, New York, NY, 10036, US

(21) Appl. No.: 11/261,320

(22) Filed: Oct. 28, 2005

(30) Foreign Application Priority Data
Nov. 12, 2004 (DE) 10 2004 054 663.0

(51) Int. Cl. F16C 32/06

(52) U.S. Cl. 384/110

(57) ABSTRACT

The invention relates to a fluid dynamic bearing arrangement which comprises a shaft having a cylindrical section and a conical section, a bearing sleeve having a cylindrical bore to receive the cylindrical section of the shaft and a conical recess to receive the conical section of the shaft, a bearing gap filled with bearing fluid being defined between the opposing surfaces of the shaft and the bearing sleeve so that the shaft and the bearing sleeve are rotatable with respect to one another. A radial bearing formed by the cylindrical sections of the bearing sleeve and the shaft, and a combined axial and radial bearing formed by the conical sections of the bearing sleeve and the shaft are provided, the conical section turning at its largest diameter into a cylindrical section having a smaller diameter, and the end face of the conical section being covered by a cover ring, an annular space being formed in which the bearing gap ends.

### BACKGROUND OF THE INVENTION

The invention relates to a fluid dynamic bearing arrangement, as used, for example, in spindle motors to drive hard disk drives, according to the characteristics cited in the preamble to claim 1.

### OUTLINE OF THE PRIOR ART

Fluid dynamic bearings are being increasingly employed as rotary bearings in spindle motors that are used, for example, to drive the disks in hard disk drives, alongside roller bearings which have long been used for this purpose. A fluid dynamic bearing is a further development on a sliding bearing and formed by a bearing sleeve having, for example, a cylindrical inner bearing surface and a shaft set into the sleeve having a corresponding outer bearing surface. The diameter of the shaft is slightly smaller than the inside diameter of the sleeve, thus producing a concentric bearing gap formed between the two bearing surfaces, the bearing gap being filled with a lubricant, preferably oil, forming a continuous capillary film.

The opposing cylindrical surfaces of the bearing sleeve and the shaft together form a radial bearing, a surface pattern being formed on at least one of the two bearing surfaces which, due to the relative rotary movement, exerts local accelerating forces on the lubricant located in the bearing gap. A kind of pumping action is created in this way which presses the lubricant through the bearing gap under pressure and results in the formation of a homogeneous lubricating film of regular thickness.

The bearing arrangement is stabilized along the rotational axis by an appropriately designed fluid dynamic axial bearing or thrust bearing. The axial bearing is formed in the familiar way through bearing surfaces of the shaft and bearing sleeve that are perpendicular or aligned transversal to the rotational axis, at least one of these bearing surfaces also being provided with a surface pattern in order to generate the hydrodynamic pressure required for stable axial positioning of the shaft and to ensure the circulation of the lubricant within the region of the axial bearing.

A disadvantage of well-known designs and constructions is that, due to the axial and radial bearing regions being arranged successively after each other, a certain overall height has to be maintained and may not be reduced otherwise the bearing cannot achieve the required stability and stiffness.

### SUMMARY OF THE INVENTION

It is thus the object of the invention to provide a fluid dynamic bearing arrangement that, despite its small-scale construction, has low runout and high stiffness. This bearing arrangement is also to be realized at low manufacturing costs.

This object has been achieved according to the invention by bearing arrangements having the characteristics found in the independent claims.

Preferred embodiments of the invention and other beneficial features are cited in the subordinate claims.

In a first preferred embodiment, the fluid dynamic bearing arrangement according to the invention comprises a shaft having a cylindrical section and a conical section, a bearing sleeve having a cylindrical bore to receive the cylindrical section of the shaft and a conical recess to receive the conical section of the shaft, a bearing gap filled with a bearing fluid being defined between the opposing surfaces of the shaft and the bearing sleeve, so that the shaft and the bearing sleeve are rotatable with respect to one another. A radial bearing is formed by the cylindrical sections of the bearing sleeve and the shaft, and a combined axial and radial bearing by the conical sections of the bearing sleeve and the shaft, the conical section of the shaft ending at its largest diameter in a cylindrical section having a smaller diameter, and the end face of the conical section being covered by a cover ring, an annular space being formed in which the bearing gap ends.

In a second preferred embodiment, the fluid dynamic bearing arrangement according to the invention comprises a shaft having a cylindrical section and a conical section, a bearing sleeve having a cylindrical bore to receive the cylindrical section of the shaft and a conical recess to receive the conical section of the shaft, a bearing gap filled with a bearing fluid being formed between the opposing surfaces of the shaft and the bearing sleeve, so that the shaft and the bearing sleeve are rotatable with respect to one another. A radial bearing is formed by the cylindrical sections of the bearing sleeve and the shaft, and a combined axial and radial bearing by the conical sections of the bearing sleeve and the shaft, the conical section of the shaft turning into a second cylindrical section that is received in a cylindrical bore in the bearing sleeve having a larger diameter, the second cylindrical section turning into another cylindrical section having a smaller diameter, and the end face of the second cylindrical section being covered by a cover ring, so that an annular space is formed in which the bearing gap ends.

The invention thus relates to a conical fluid dynamic bearing in conjunction with a radial fluid dynamic bearing. The axial loads acting on the bearing are absorbed in one direction by the conical bearing and in the opposite direction by axial preloading, realized, for example, by magnetic means. The radial loads are absorbed by both the conical bearing as well as the radial bearing.

According to a preferred embodiment of the invention, the conical axial/radial bearing comprises asymmetric surface patterns which generate an uneven hydrodynamic pressure in the bearing fluid and pump the bearing fluid mainly in the direction of the radial bearing. The radial bearing preferably comprises symmetric surface patterns by means of which an even hydrodynamic pressure is generated in opposite directions.

A horizontal seal to seal the end of the bearing gap can preferably be provided, the end face of the conical section of the shaft being slanted in such a way that the axial height of the annular space decreases radially outwards in the direction of the bearing gap. The bearing fluid is therefore found in an annular cavity tapering radially outwards between the shaft, or a part connected to the shaft respectively, and the bearing bush, or a part fixedly connected to the bearing bush respectively, taking, for example, the shape of the cover ring. The space is at least partially filled with bearing fluid. In addition to the prevailing capillary action between the bearing fluid and the sealing surfaces surrounding the space, when the shaft or the bearing is moved, the bearing fluid is pressed radially outwards, i.e. into the bearing gap, as a result of the centrifugal force.

As an alternative, it is also possible to create the radially outwards tapering space of the capillary seal by having the cover ring slanted instead of the end face of the conical section. In both cases, the cover ring is fixedly connected to the bearing sleeve.

The bearing gap can alternatively be sealed in a vertical direction, i.e. an axial direction, in that an annular groove, which acts as a sealing reservoir for the bearing fluid, is provided in the cylindrical bore having the larger diameter or in the conical recess of the bearing sleeve.

The bearing arrangement is closed at one end in that the lower end faces of the bearing sleeve and the shaft are covered by a cover plate. The bearing gap ends in a disk-shaped space between the end face of the shaft and the cover plate.

To absorb large axial loads and to hold the shaft in position at all events, an annular groove can be provided at the end of the cylindrical bore of the bearing sleeve adjoining the cover plate, a retaining ring enclosing the outside diameter of the shaft being disposed in this groove.

The shaft and its cylindrical and conical sections can be integrally formed as one piece or consist of two separate parts joined together, for example, by an interference fit.

A recirculation channel can be provided in the bearing sleeve that connects the bearing gap at one end of the shaft to the outside diameter of the conical bearing and the ambient pressure in order to stabilize the spacing between the shaft and the bearing sleeve, i.e. the width of the bearing gap. The recirculation channel also makes it easier to vent the bearing gap after the bearing has been filled with bearing fluid. The cover plate or the end face of the shaft opposite the cover plate can be given a spiral surface pattern to aid the circulation (and venting) of the bearing fluid. It is preferable, however, if this surface pattern does not act as an axial bearing, i.e. an axial load is not generated by the surface pattern.

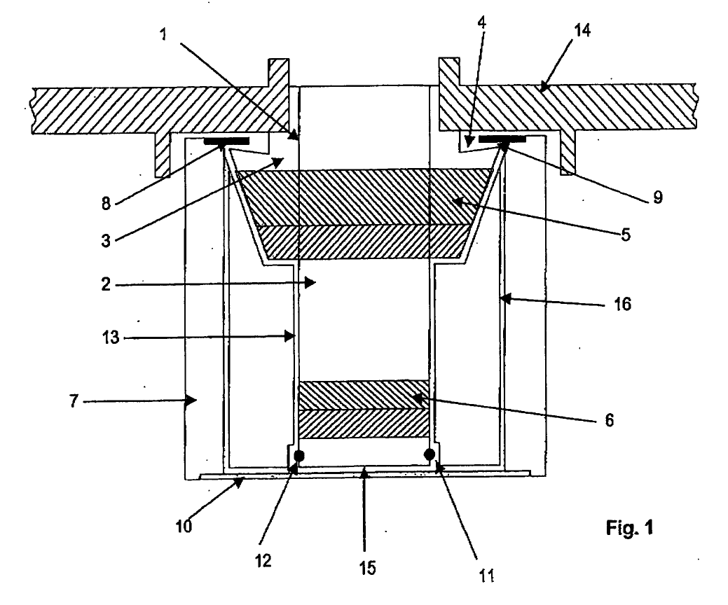

FIG. 1 shows a first embodiment of the fluid dynamic bearing arrangement having a horizontal sealing structure;

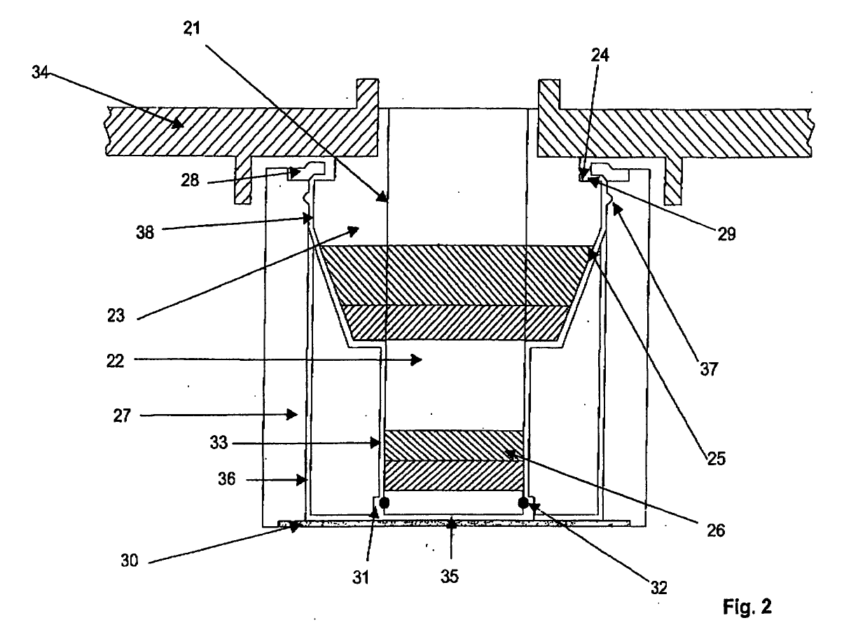

FIG. 2 shows a second embodiment of the fluid dynamic bearing arrangement having a vertical sealing structure.

FIG. 1 shows a cross-section through a first schematic embodiment of a fluid dynamic bearing arrangement according to the invention. The bearing arrangement comprises a shaft 1 rotating in a bearing bush 7, the shaft having a cylindrical section 2 and a conical section 3. In the illustrated embodiment, the cylindrical section 2 and the conical section 3 form two separate parts which are connected to each other, for example, by means of an interference fit. The bearing sleeve 7 comprises a cylindrical bore to receive the cylindrical section 2 of the shaft 1 and a conical recess to receive the conical section 3 of the shaft. The inside diameter of the bore or recess of the bearing sleeve 7 is slightly larger than the corresponding outside diameter of the cylindrical section 2 or the conical section 3 of the shaft 1, so that a bearing gap 13 filled with bearing fluid remains between the opposing surfaces of the shaft 1 and the bearing sleeve 7. This makes the shaft 1 and the sleeve 7 rotatable with respect to one another about a common rotational axis. According to the invention, the cylindrical section 2 of the shaft 1 comprises surface patterns 6 that define a radial bearing. As a person skilled in the art is aware, the surface patterns 6 could also be located fully or partially on the corresponding inner surface of the bearing sleeve 7. The conical section 3 of the shaft 1 also has surface patterns 5 on its outside circumference that define a combined axial/radial bearing. As is well-known, the surface patterns 5 could also be fully or partially located on the opposing inner surfaces of the bearing sleeve 7. By giving the surface patterns 6, 5 of the radial bearing or of the combined axial/radial bearing an appropriate design, a pumping action is exerted on the lubricant in the bearing gap 13 when the shaft 1 rotates in the bearing sleeve 7. Due to the rotation of the shaft, hydrodynamic pressure is built up which provides for the centering of the shaft within the bearing sleeve and thus ensures a uniform width of the bearing gap 13 over the circumference of the bearing and determines the load-bearing capacity of the fluid dynamic bearing system.

The opening of the bearing gap 13 in the region of the conical section 3 of the shaft is covered by a cover ring 8. The cover ring 8 seals the bearing gap 13 from above and prevents bearing fluid from escaping due to a dynamic sealing action produced by capillary forces. The end face 4 of the conical section 3 of the shaft 1 is slightly slanted, so that between the end face 4 and the inner surface of the cover ring 8, an annular space 9 tapering radially outwards is created. This space 9 leads into the bearing gap 13. The space 9 is partially filled with bearing fluid and forms a reservoir for the bearing fluid, which, due to centrifugal forces, is pressed radially outwards from the space 9 into the bearing gap 13 when the shaft 1 rotates within the bearing sleeve 7.

The surface patterns 5 of the conical region of the bearing are preferably made asymmetric, i.e. they generate less pressure upwards in the direction of the opening of the bearing gap 13 than they do downwards in the direction of the radial bearing region. The surface patterns 6 of the radial bearing region are preferably made symmetric, i.e. they generate approximately the same pumping effect in both directions of the continuing bearing gap 13 and thus the same pressure. Since the illustrated fluid dynamic bearing arrangement has only one axial bearing acting in one direction whose load is directed in the direction of the cover ring 8, to compensate for this load, axial preloading of the bearing in the direction of the cover plate 10 has been provided. This preloading can be realized, for example, by magnetic means (not illustrated).

The lower region of the bearing is sealed by a cover plate 10 preferably disposed in a recess in the bearing sleeve 7. The bearing gap 13 ends in a disk-shaped space between the inner surface of the cover plate 10 and the end face of the shaft 1 or the bearing sleeve 7.

A retaining ring 12 is arranged at the lower end of the shaft 1, the retaining ring holding the shaft in position when excessive axial loads are exerted in that the retaining ring 12 is accommodated in an annular groove 11 in the bearing sleeve 7. The shaft 1 or its conical section 3 carries a rotor 14 as part of an electric motor, for example, whose other components are not illustrated here.

A recirculation channel 16 in the bearing sleeve 7 connects the bearing gap 13 in the lower region of the bearing, i.e. between the end face 15 of the shaft 1 and the cover plate 10, to the upper end of the bearing gap, shortly before the bearing gap 13 leads into the space 9. This recirculation channel 16 ensures an even circulation of the bearing fluid within the bearing gap 13 and stabilizes the width of the bearing gap 13, particularly in the conical bearing region.

The end face 15 of the shaft 1 or the opposing surface of the cover plate 10 can likewise have surface patterns which aid the circulation of the bearing fluid.

FIG. 2 shows a section through an embodiment modified vis-à-vis the bearing arrangement according to FIG. 1. A shaft 21 rotating in a bearing bush 27 has a first cylindrical section 22, an adjoining conical section 23 and a second cylindrical section 38 having a larger diameter which in turn adjoins the conical section. As already explained in conjunction with FIG. 1, the respective cylindrical sections 22, 38 or the conical section 23 of the shaft 21 are received in correspondingly shaped recesses in the bearing sleeve 27, a bearing gap 33 remaining between the surfaces facing each other of the shaft 21 and the bearing sleeve 27. The bearing gap is filled with a bearing fluid. The lower end of the bearing is sealed by a cover plate 30, the bearing gap 33 ending in a disk-shaped space that is formed between the end faces of the bearing sleeve 27 or of the shaft 21 and the inner surface of the cover plate 30. Appropriate surface patterns 25, 26 on the conical section 23 or the cylindrical section 22 of the shaft 21 define a combined axial/radial bearing or a radial bearing, as already described above in conjunction with FIG. 1. The bearing obtains its load-bearing capacity through the pumping effect on the bearing fluid generated by the surface patterns 25, 26 and the associated build-up of pressure within the bearing gap 33.

The upper opening of the bearing gap 33 at the end of the second cylindrical section 38 is sealed by a cover ring 28 that prevents bearing fluid from escaping when subject to shock (called an “oil catcher”). The cover ring is curved radially inwards or slanted in such a way that the axial height of the annular space 29 formed between the cover ring and the end face 24 of the conical section, is decreased radially outwards in the direction of the bearing gap 33. During normal operating conditions and also when the shaft is at a standstill, no bearing fluid is found in the space 29.

In the region of the cylindrical section 38, an annular groove 37 can be provided on the inside diameter of the bearing sleeve 27, the annular groove acting simultaneously as a capillary seal and as an oil reservoir (called a “straight seal”). At the lower end of the shaft 21, a retaining ring 32 can be provided which is disposed in an annular groove 31 in the bearing sleeve 27 provided for this purpose. The bearing arrangement can form a part of an electric motor whose rotor 34, for example, is connected to the upper end of the shaft 21. To improve the circulation of the bearing fluid within the bearing gap 33, a recirculation channel 36 can be provided which connects the lower section of the bearing gap, i.e. the region between the end face 35 of the shaft 21 and the inner surface of the cover plate 30, to the upper region of the bearing gap, for example, the region of the bearing gap above the axial/radial bearing arrangement.

### IDENTIFICATION REFERENCE LIST

1 Shaft
2 Cylindrical section of the shaft
3 Conical section of the shaft
4 End face of the cone
5 Surface pattern
6 Surface pattern
7 Bearing sleeve
8 Cover ring
9 Space
8 Cover plate
11 Annular groove
12 Retaining ring
13 Bearing gap
14 Rotor
15 End face of the shaft
16 Recirculation channel
21 Shaft
22 Cylindrical section of the shaft
23 Conical section of the shaft
24 End face of the cone
25 Surface pattern
26 Surface pattern
27 Bearing sleeve
28 Cover ring
29 Space
28 Cover plate
31 Annular groove
32 Retaining ring
33 Bearing gap
34 Rotor
35 End face of the shaft
36 Recirculation channel
37 Annular groove (reservoir)
38 Cylindrical section

1. A fluid dynamic bearing arrangement comprising:
a shaft (1) having a cylindrical section (2) and a conical section (3);
a bearing sleeve (7) having a cylindrical bore to receive the cylindrical section (2) of the shaft and a conical recess to receive the conical section (3) of the shaft, a bearing gap (13) filled with bearing fluid being defined between the opposing surfaces of the shaft and the bearing sleeve, the shaft and the bearing sleeve being rotatable with respect to one another, a radial bearing formed by the cylindrical sections of the bearing sleeve and the shaft, and a combined axial and radial bearing formed by the conical sections of the bearing sleeve and the shaft,
the conical section turning at its largest diameter into a section having a smaller diameter and the end face (4) of the conical section being covered by a cover ring (8), so that an annular space (9) is formed that leads into the bearing gap (13).

2. A fluid dynamic bearing arrangement comprising:
a shaft (21) having a cylindrical section (22) and a conical section (23);
a bearing sleeve (27) having a cylindrical bore to receive the cylindrical section (22) of the shaft and a conical recess to receive the conical section (23) of the shaft, a bearing gap (33) filled with bearing fluid being formed between the opposing surfaces of the shaft and the bearing sleeve, the shaft and the bearing sleeve being rotatable with respect to one another,
a radial bearing formed by the cylindrical sections of the bearing sleeve and the shaft, and a combined axial and radial bearing formed by the conical sections of the bearing sleeve and the shaft, the conical section (23) of the shaft turning into a second cylindrical section (38) that is received in a cylindrical bore in the bearing sleeve (27) having a larger diameter, the second cylindrical section (38) turning into a third section having a smaller diameter, and the end face (24) of the second cylindrical section being covered by a cover ring (28), an annular space (29) being formed in which the bearing gap (33) ends.

3. A fluid dynamic bearing according to claim 1 or 2, characterized in that the end face (4) is slanted such that the axial height of the annular space (9) decreases radially outwards in the direction of the bearing gap (13).

4. A fluid dynamic bearing according to one of the claims 1 to 3, characterized in that the cover ring (8) is slanted such that the axial height of the annular space (9) decreases radially outwards in the direction of the bearing gap (13).

5. A fluid dynamic bearing according to one of the claims 1 to 4, characterized in that the cover ring (8; 28) is fixedly connected to the bearing sleeve (7; 27).

6. A fluid dynamic bearing according to one of the claims 1 to 5, characterized in that the space (9) at least partially filled with bearing fluid.

7. A fluid dynamic bearing according to one of the claims 1 to 6, characterized in that the radial bearing and the conical axial/radial bearing are defined by surface patterns (5, 6; 25, 26) that are disposed on the outer surface of the shaft (1; 21) and/or on the inner surface of the bearing sleeve (7; 27).

8. A fluid dynamic bearing according to one of the claims 1 to 7, characterized in that the conical axial/radial bearing comprises asymmetric surface patterns (5; 25) that generate an asymmetric pressure build-up in the direction of the radial bearing.

9. A fluid dynamic bearing according to one of the claims 1 to 8, characterized in that the radial bearing comprises symmetric surface patterns (6; 26).

10. A fluid dynamic bearing according to one of the claims 1 to 9, characterized in that an annular groove (37) is provided in the cylindrical bore having the larger diameter or in the conical recess of the bearing sleeve (27), the annular groove being at least partially filled with bearing fluid.

11. A fluid dynamic bearing according to one of the claims 1 to 10, characterized in that the lower end face of the bearing sleeve (7; 27) is covered by a cover plate (10; 30).

12. A fluid dynamic bearing according to one of the claims 1 to 11, characterized in that an annular groove (11, 31) is provided at the end of the cylindrical bore of the bearing sleeve adjoining the cover plate (10; 30) in which a retaining ring (12; 32) attached to the outside diameter of the shaft is disposed.

13. A fluid dynamic bearing according to one of the claims 1 to 12, characterized in that the cylindrical (2; 22) and the conical section (3; 23) of the shaft consist of two parts connected to each other.

14. A fluid dynamic bearing according to one of the claims 1 to 13, characterized in that at least one recirculation channel (16; 36) is provided within the bearing sleeve (7; 27) that connects the region of the bearing gap of the conical section and the region of the bearing gap between the cover plate and the end of the shaft to each other.

15. A fluid dynamic bearing according to one of the claims 1 to 14, characterized in that it is preloaded by (electro) magnetic means against the pumping effect of the conical bearing.
